(19) United States
(12) Patent Application Publication
(10) Pub. No.: US 2025/0189548 A1
(43) Pub. Date: Jun. 12, 2025

(54) SYSTEM AND APPARATUS FOR GRIPPING BIOLOGICAL PROCESSING PLATES

(71) Applicant: Trilobio, Inc., San Francisco, CA (US)

(72) Inventors: Maximilian Eugene SCHOMMER, Huntington Beach, CA (US); Roya AMINI-NAIENI, Huntington Beach, CA (US); Keoni Kealoha GANDALL, Huntington Beach, CA (US)

(73) Assignee: Trilobio, Inc., San Francisco, CA (US)

(21) Appl. No.: 18/856,515

(22) PCT Filed: Apr. 14, 2023
(86) PCT No.: PCT/US2023/018679

§ 371 Date: Oct. 11, 2024

Related U.S. Application Data
(60) Provisional application No. 63/362,968, filed on Apr. 14, 2022.

(51) Int. Cl. G01N 35/00; B01L 3/00

(52) U.S. Cl. CPC G01N 35/00029; B01L 3/50853; G01N 35/0099; B01L 2300/0829

(57) ABSTRACT

A system includes a plate, a robotic arm, a gripper, and a plate holder. The plate includes a plurality of sides, a bottom surface, and a top surface. The gripper is coupled to the robotic arm and supports the plate from underneath. The gripper includes gripper arms and inserts the gripper arms underneath the plate from opposing lateral directions. The plate holder is sized and shaped to support the plate. The plate holder includes recessed edges that allow the gripper arms sufficient access to opposing sides of the plurality of sides of the plate and portions of the bottom surface of the plate adjacent to the opposing sides of the plate. The plate holder includes alignment guides configured to align the plate with a predetermined position on the plate holder.

### CROSS-REFERENCE TO RELATED APPLICATIONS AND INCORPORATION BY REFERENCE

The following application is incorporated herein by reference in its entirety: US 63/362,968.

### BACKGROUND

### Field

Aspects of the present disclosure relate to biological processing systems and apparatuses, for example, gripper tools that support biological processing plates.

### Background

Biological laboratory processing requires many distinct processes to be performed on a variety of samples. These processes include transferring samples from one place to another, pipetting samples, covering samples with protective lids, and many others. Additionally, it is desirable to avoid spillage and cross-contamination of samples. Because of the vast quantity of processes required for biology and the precious nature of samples, biology labs can use a robotic system for moving and placing plates containing samples in target areas for study.

Current robotic systems use grippers that hold onto plates by gently squeezing the plates from opposing sides, using friction forces to maintain a grip. However, these grippers can be unreliable because any slight change in friction force, imbalance, or misalignment can cause the plate to tip and/or slip from the gripper's hold.

### BRIEF DESCRIPTION OF THE DRAWINGS

The accompanying drawings, which are incorporated herein and form part of the specification, illustrate the present disclosure and, together with the description, further serve to explain the principles of the present disclosure and to enable those skilled in the relevant art(s) to make and use aspects described herein.

FIGS. 1A-1B illustrate top and front cross-section views, respectively, of a prior art robotic plate gripper system, according to some aspects.

FIGS. 2A-2C illustrate top, front cross-section, and perspective views, respectively, of a plate holder, according to some aspects.

FIGS. 3A-3C illustrate top, front cross-section, and perspective views, respectively, of a plate holder supporting a plate, according to some aspects.

FIG. 4 illustrates a front view of alignment guides aligning a plate on a plate holder, according to some aspects.

FIG. 5A-5C illustrate front, side, and perspective views, respectively, of a gripper accessing regions adjacent to recessed edges of a plate holder, according to some aspects.

FIG. 6A illustrates a front cross-section view of a gripper system, according to some embodiments.

FIGS. 6B-6C illustrate front cross-section and perspective views, respectively, of a gripper system supporting a plate, according to some aspects.

### DETAILED DESCRIPTION

This specification discloses one or more aspects that incorporate the features of this present invention. The disclosed aspect(s) merely exemplify the present invention. The scope of the invention is not limited to the disclosed aspect(s). The present invention is defined by the claims appended hereto.

The aspect(s) described, and references in the specification to “one aspect,” “an aspect,” “an example aspect,” “an exemplary aspect,” etc., indicate that the aspect(s) described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is understood that it is within the knowledge of one skilled in the art to effect such feature, structure, or characteristic in connection with other aspects whether or not explicitly described.

Spatially relative terms, such as “beneath,” “below,” “lower,” “above,” “on,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The term “about” or “substantially” or “approximately” as used herein indicates the value of a given quantity that can vary based on a particular technology. Based on the particular technology, the term “about” or “substantially” or “approximately” can indicate a value of a given quantity that varies within, for example, 1-15% of the value (e.g., ±1%, ±2%, ±5%, ±10%, or ±15% of the value).

Before describing such aspects in more detail, however, it is instructive to present the current state of the art upon which the present disclosure improves.

### Prior Art Robotic System

A biological processing environment may include a variety of locations containing equipment for use in a given process. A robotic system can transfer materials, such as a plate, to necessary locations within the biological processing environment. The robotic system can include grippers for supporting the materials during the transfer.

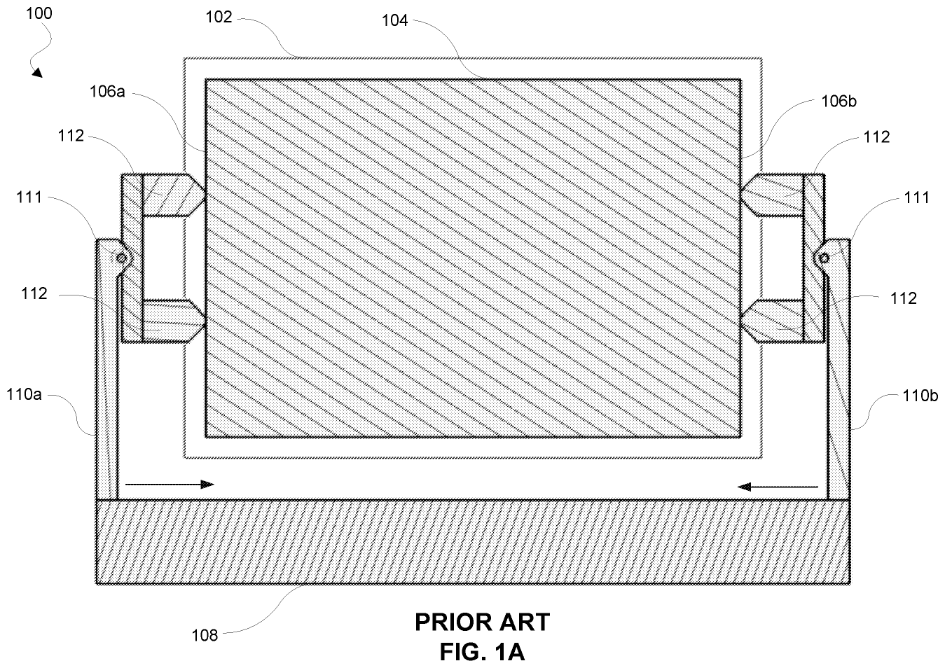

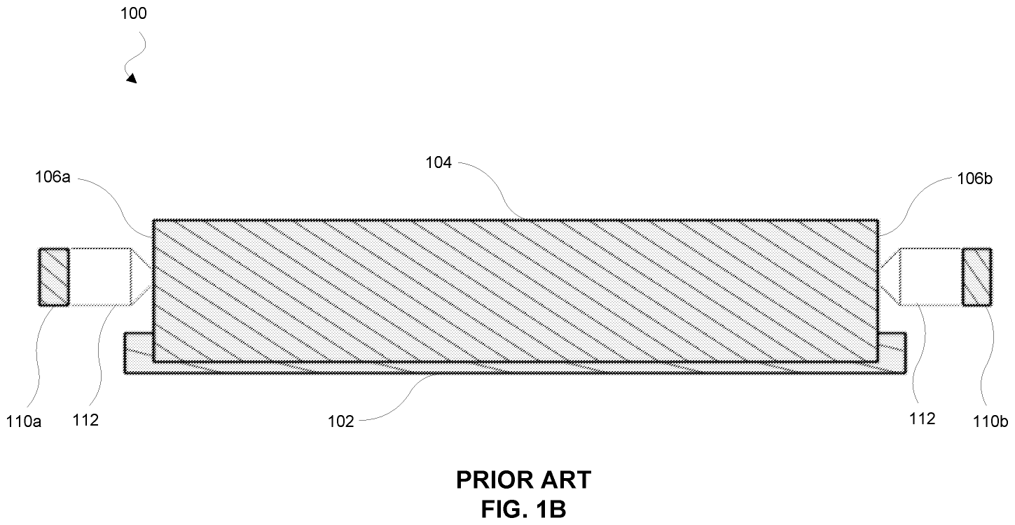

FIGS. 1A-1B illustrate top and side cross-section views, respectively, of a prior art robotic plate gripper system 100, according to some aspects. In some aspects, prior art robotic plate gripper system 100 can include a plate holder 102, a plate 104, and a gripper 108. Prior art robotic plate gripper system 100 can utilize gripper 108 to support and move plate 104 to and from plate holder 102.

Plate holder 102 typically cradles plate 104 such that only top portions of plate sides 106a, 106b are exposed. As a result, the design of plate holder 102 limits access for how gripper 108 can hold plate 104 because the bottom of plate 104 is completely occluded.

Gripper 108 is typically equipped with gripper arms 110a, 110b arranged in parallel. Gripper arms 110a, 110b are mounted on gripper 108 at a proximal end. A distal end of gripper arms 110a, 110b can engage with plate 104 to support plate 104 during a transfer. Gripper arms 110a, 110b are typically configured to use prongs 112 to engage with plate sides 106a, 106b. Prongs 112 can be a metallic material or an elastomer material like rubber.

Due to the cradle design of plate holder 102, gripper 108 can only grasp plate 104 by squeezing top portions of plate sides 106a, 106b from opposing sides, thereby relying on friction forces to maintain a grip. However, gripper 108 can be unreliable because gripper 108 moves gripper arms 110a, 110b inward from the proximal end of gripper arms 110a, 110b, thereby introducing an undesirable torque on the distal end of gripper arms 110a, 110b. Consequently, any twisting of gripper arms 110a, 110b, or misalignment or imbalance of plate 104, can change the friction forces supporting plate 104, thereby causing plate 104 to tip and/or slip from the grasp of gripper 108. Additionally, the maximum mass of plate 104 that gripper 108 can handle is determined by the grip force of gripper 108, as well as the mutual coefficient of friction between gripper 108 and plate 104. For unknown plate surface textures or materials, it can be unpredictable whether gripper 108 is capable of stably lifting plate 104. Therefore, prior art robotic plate gripper system 100 has a fundamentally unstable design.

While current attempts at resolving the undesirable torque have improved the support structure of gripper 108, these attempts introduce complexity and/or leave the gripping predictability issue unaddressed. For example, pivots 111 have been introduced in some prior art gripper systems in an effort to counteract the undesirable torque with an opposite rotation. While pivots 111 have been helpful to equalize forces, they complicate the gripper design with more moving parts and do not resolve the gripping predictability issue. To monitor the friction forces, gripper 108 can employ force sensors to detect any uneven distribution of force across prongs 112. But such a monitoring configuration is both complicated and expensive to monitor. Thus, prior art robotic plate gripper system 100 contains fundamental design flaws that have remained unresolved.

### Exemplary Gripper System

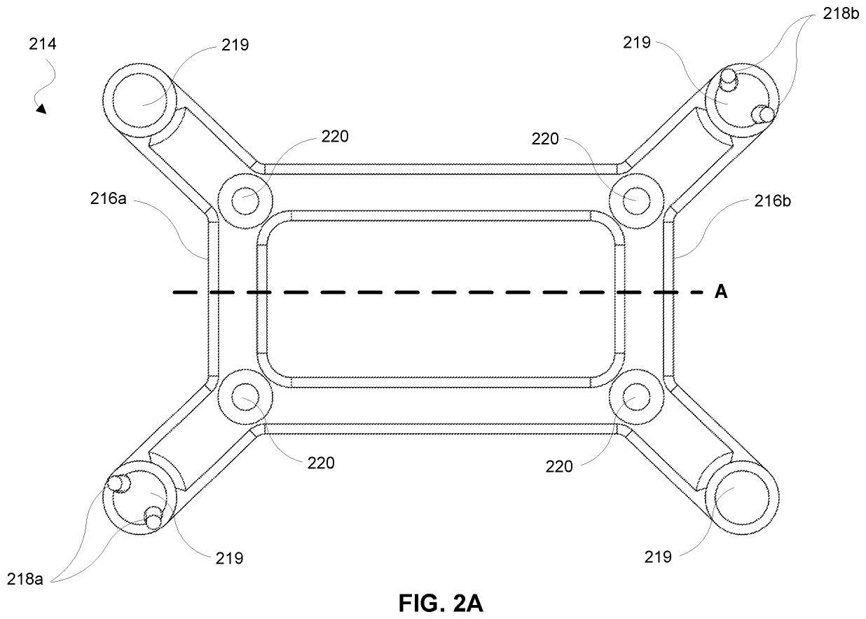

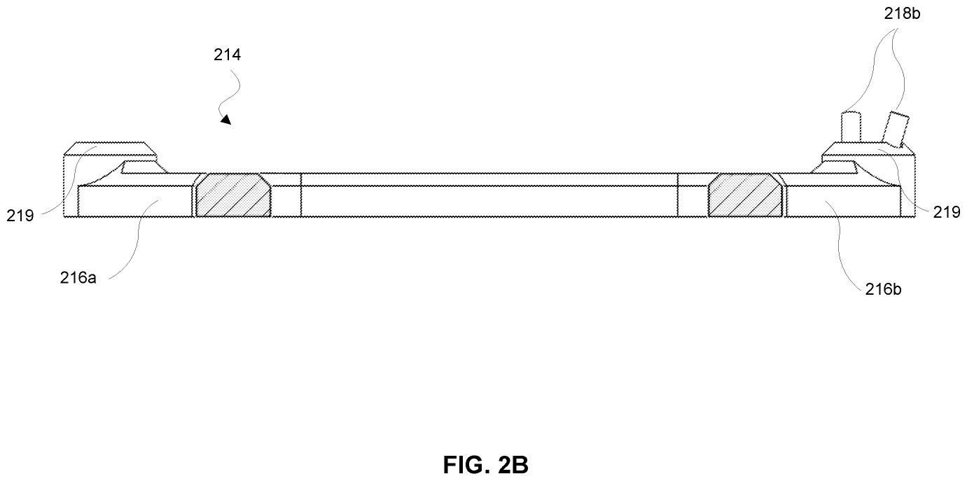

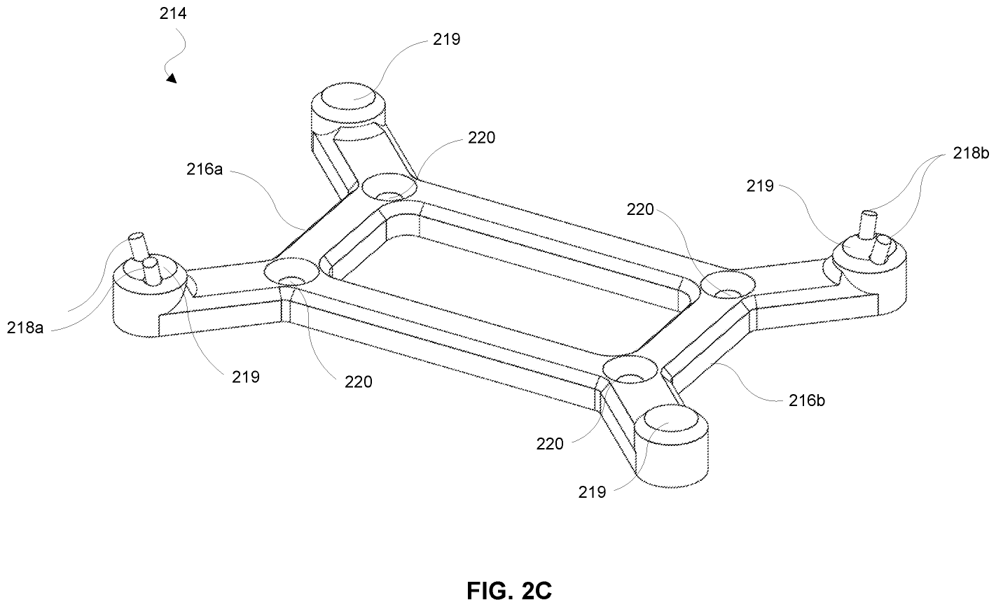

FIGS. 2A-2C illustrate top, front cross-section, and perspective views, respectively, of a plate holder 214, according to some aspects. FIG. 2B is a front cross-section taken along line A shown in FIG. 2A. Plate holder 214 can include recessed edges 216a, 216b, alignment guides 218a, 218b, plate rests 219, and mounting sites 220.

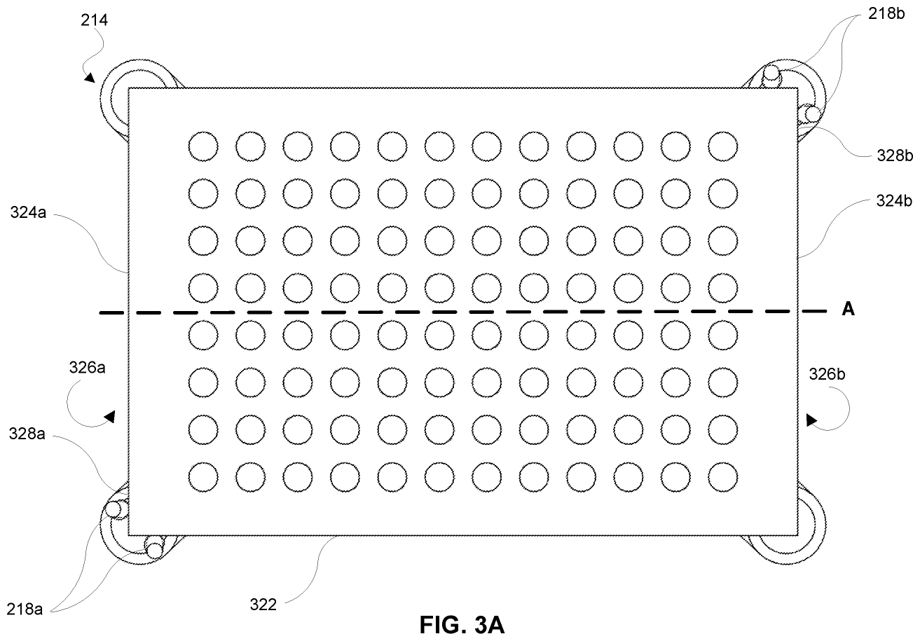

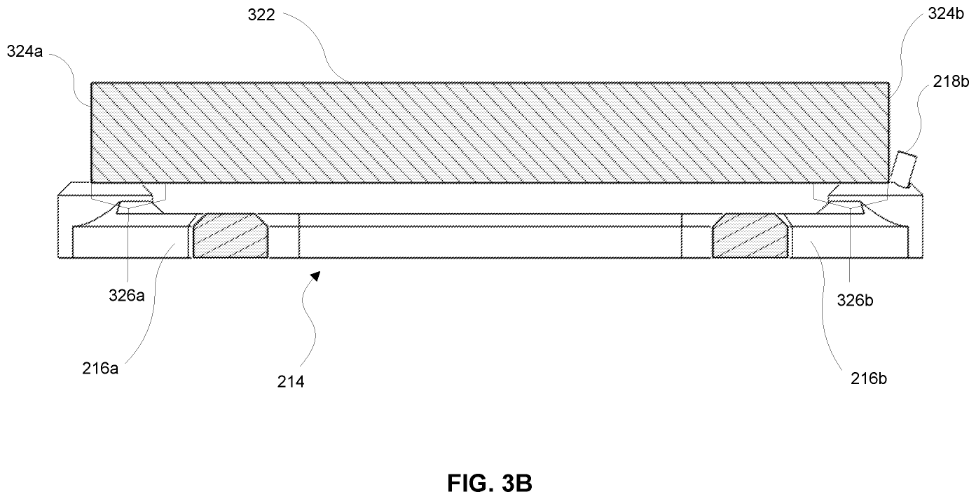

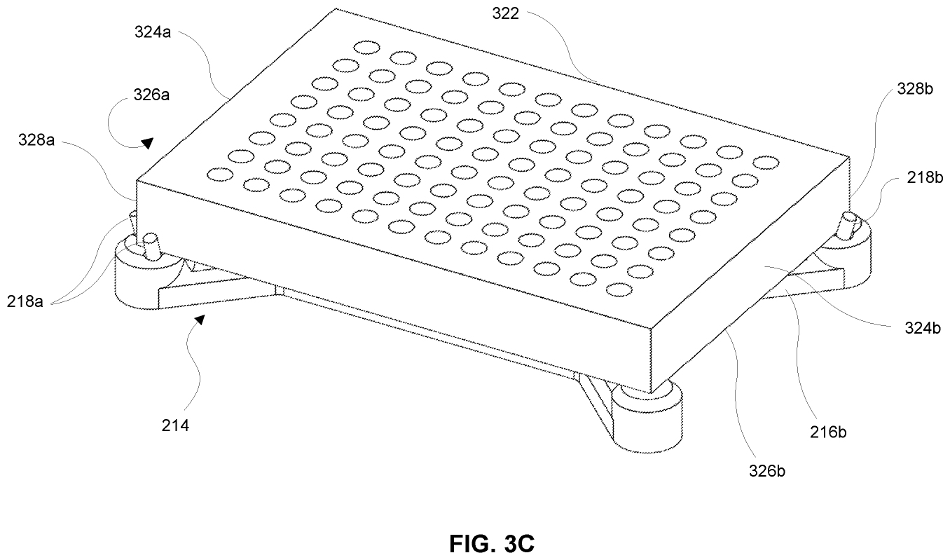

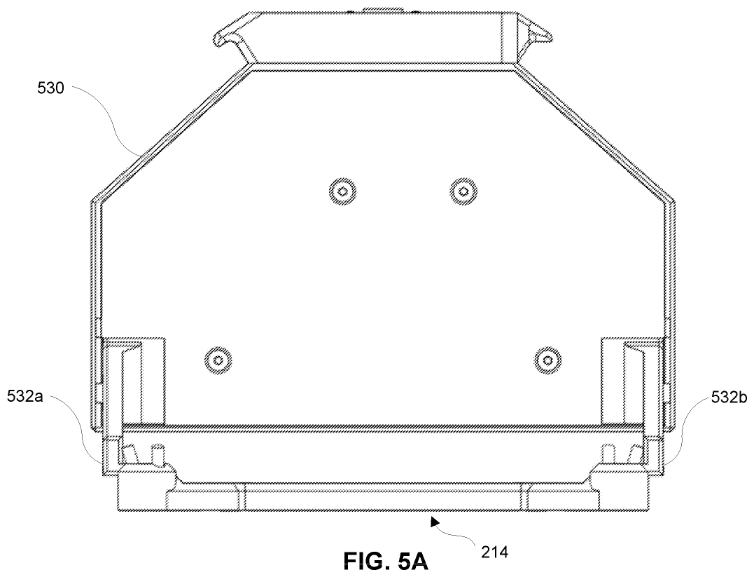

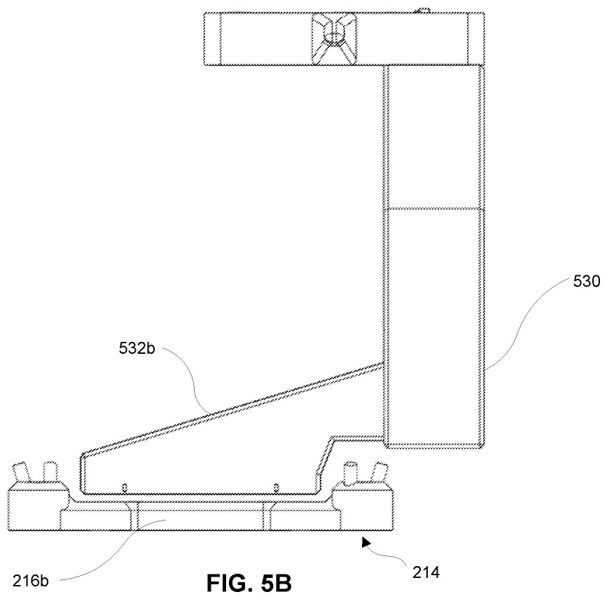

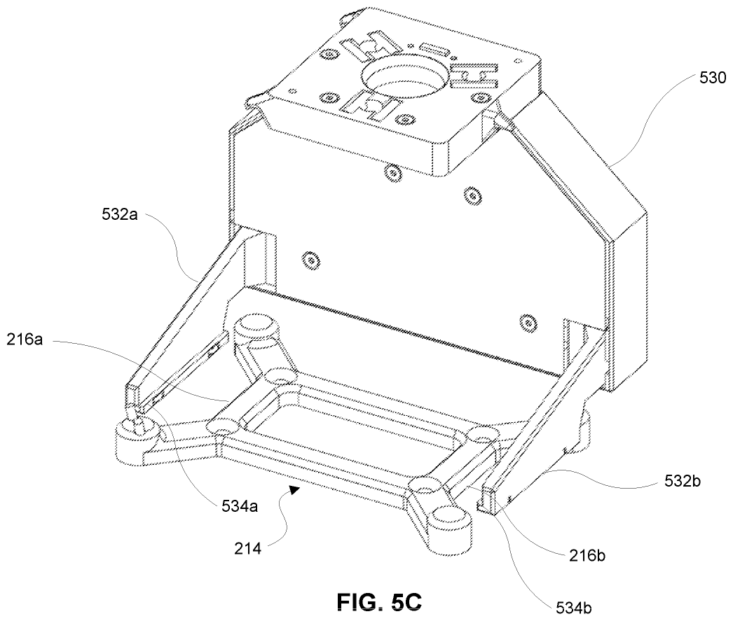

In some aspects, plate holder 214 can be sized and shaped to support a plate 322 (as shown in and further described with respect to FIGS. 3A-3C). In some aspects, plate holder 214 can include recessed edges 216a, 216b configured to allow gripper arms 532a, 532b (as shown in and further described with respect to FIGS. 5A-5C) sufficient access to opposing sides of a plurality of sides of plate 322 and portions of a bottom surface of plate 322 adjacent to the opposing sides of plate 322. In one example aspect, plate holder 214 can be shaped in or similar to an “X” shape such that plate holder includes recessed edges on opposing sides of a plurality of sides. The design of plate holder 214 can allow for various configurations of how gripper arms 532a, 532b (as shown in FIG. 5A-5C) can lift plate 322, because portions of the bottom surface of plate 322 is exposed and accessible. A skilled artisan will recognize that a plate holder in accordance with aspects of the invention can be shaped in other shapes, so long as there are recessed edges on opposing sides of the plate holder that allow access to opposing portions of a bottom surface of a plate when the plate is placed on top of the plate holder. Therefore, plate holder 214 is an improvement on the cradle design of prior art plate holder 102.

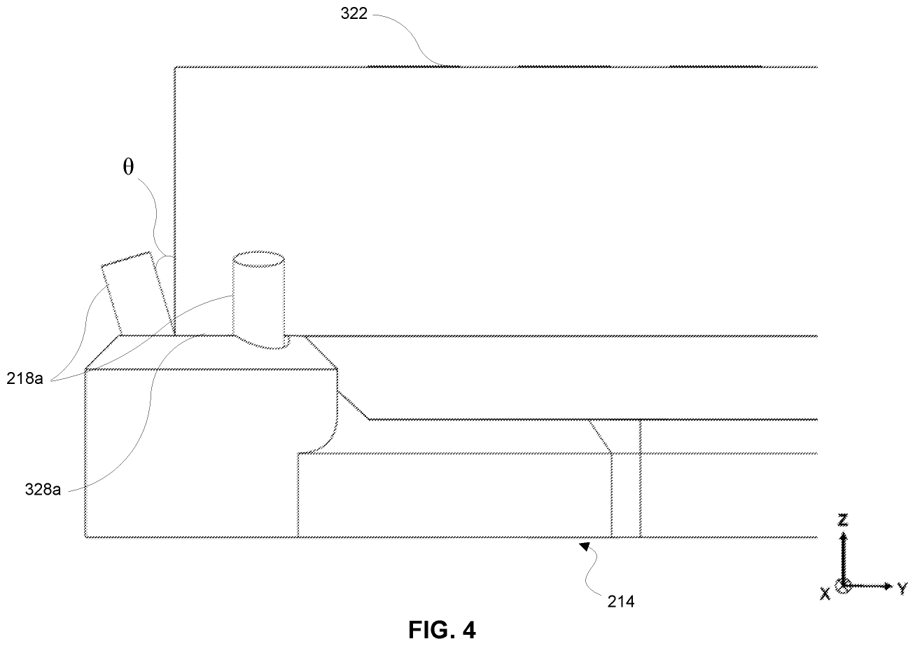

In some aspects, plate holder 214 can include alignment guides 218a, 218b configured to align plate 322 with a predetermined position on plate holder 214. In some aspects, alignment guides 218a, 218b can be disposed on opposite corners of plate holder 214. In some aspects, alignment guides 218a, 218b can be angled guide pins disposed on opposite corners of plate holder 214. Further details regarding example alignment guides in accordance with aspects of the present invention are provided with respect to FIG. 4. In some aspects, alignment guides 218a, 218b can serve a dual function of aligning plate 322 and holding plate 322 in secure alignment once plate 322 has been placed on plate holder 214.

In some aspects, plate holder 214 can include mounting sites 220 compatible with attachment areas on a mounting deck. In some aspects, mounting sites 220 can attach plate holder 214 to the mounting deck by way of fasteners such as bolts, adhesive, magnets, clips, rotatable cams, and the like.

FIGS. 3A-3C illustrate top, front cross-section, and perspective views, respectively, of a plate holder 214 supporting a plate 322, according to some aspects. FIG. 3B is a front cross-section taken along line A shown in FIG. 3A. In some aspects, plate 322 can include a plurality of sides, a bottom surface, and a top surface. In some aspects, plate holder 214 can support plate 322 such that plate sides 324a, 324b are at least partially exposed and accessible. In some aspects, plate holder 214 can support plate 322 such that plate bottom surface portions 326a, 326b are exposed and accessible. For example, plate bottom surface portions 326a, 326b, adjacent to plate sides 324a, 324b respectively, can overhang recessed edges 216a, 216b of plate holder 214. In some aspects, plate holder 214 can support plate 322 by making contact with an interior portion of the bottom surface of plate 322. In some aspects, plate holder 214 can additionally or alternatively support plate 322 by making contact with corners of plate 322. In some aspects, plate holder 214 can support plate 322 by making contact with portions of the bottom surface of plate 322 that are adjacent to sides of plate 322 other than sides 324a, 324b. In some aspects, alignment guides 218a, 218b can make contact with plate corners 328a, 328b to align plate 322 with a predetermined position on plate holder 214.

In some aspects, plate 322 can be used for biological processing. In some aspects, plate 322 includes at least one of biological sample wells, tip racks, or test tube holders. For example, plate 322 can be a 96-well biological processing plate.

In some aspects, plate 322 can be formed in any shape or size. In some aspects, plate 322 can conform to microplate size standards set forth in 2004 by the American National Standards Institute (ANSI) and the Society for Laboratory Automation and Screening (SLAS), as reaffirmed in 2017, the microplate sizing aspects of which are herein incorporated by reference: ANSI SLAS 1-2004 (R2012): Footprint Dimensions (last updated Jan. 9, 2004); ANSI SLAS 2-2004 (R2012): Height Dimensions (last updated Jan. 9, 2004); ANSI SLAS 3-2004 (R2012): Bottom Outside Flange Dimensions (last updated Jan. 9, 2004); ANSI SLAS 4-2004 (R2012): Well Positions (last updated Jan. 9, 2004); and ANSI SLAS 6-2012: Well Bottom Elevation (last updated Apr. 9, 2009). In one example aspect, plate 322 can have a length of about 127.76 mm and a width of about 85.48 mm. A skilled artisan would recognize that such dimensions can have a tolerance of about ±0.5 mm.

FIG. 4 illustrates a side view of alignment guides 218a, 218b aligning plate 322 on a plate holder 214, according to some aspects. In some aspects, plate holder 214 can include alignment guides 218a, 218b configured to align plate 322 with a predetermined position on plate holder 214. In some aspects, alignment guides 218a, 218b can be disposed on opposite corners of plate holder 214, or on multiple other corners. In some aspects, alignment guides 218a, 218b can be angled guide pins disposed on opposite corners of plate holder 214. In some aspects, the angled guide pins can be disposed in a “V” shape that fits around a corner of plate 322. In some aspects, alignment guides 218a, 218b can make contact with corners of plate 322 to align plate 322 with a predetermined position on plate holder 214. In an example aspect, alignment guides 218a, 218b can make contact with plate corners 328a, 328b.

In some aspects, alignment guides 218a, 218b can align plate 322 in the X-and Y-directions and plate rests 219 align plate 322 in the Z-direction. In some aspects, alignment guides can be disposed at an angle theta θ from the vertical axis to slide plate 322 into a predetermined position on plate holder 214 when plate 322 is placed on plate holder 214 from above. The angle theta θ can allow for positional tolerance when plate 322 is placed on plate holder 214 because alignment guides 218a, 218b can automatically slide plate 322 into the predetermined position on plate holder 214 as plate 322 slides down (e.g., in a vertical direction) one or more of alignment guides 218a, 218b. With this configuration, alignment guides 218a, 218b can ensure that plate 322 is properly placed such that plate bottom surface portions 326a, 326b overhang recessed edges 216a, 216b of plate holder 214.

FIG. 5A-5C illustrate front, side, and perspective views, respectively, of gripper 530 accessing regions adjacent to recessed edges of plate holder 214, according to some aspects. In some aspects, gripper 530 can be sized and shaped for seamless movement between a plurality of plate holders 214 without incurring collisions. In some aspects, gripper 530 can include gripper arms 532a, 532b. Gripper 530 can be configured to move gripper arms 532a, 532b from opposing lateral directions into regions adjacent to recessed edges of a plate holder 214. In some aspects, gripper arms 532a, 532b can move into regions adjacent to recessed edges 216a, 216b. In some aspects, gripper arms 532a, 532b can be sized and shaped to occupy the regions without colliding into plate holder 214.

In some aspects, gripper arms 532a, 532b can be permanently coupled to gripper 530 as one cohesive apparatus. In some aspects, gripper arms 532a, 532b can be detachable from gripper 530 as a modular feature.

As illustrated in FIG. 5C, gripper arms 532a, 532b can each include a lateral portion 534a, 534b, respectively, that protrudes inwardly from a side portion of gripper arms 532a, 532b, thereby shaping gripper arms 532a, 532b into an “L” shape. This lateral portion 534a, 534b is sized and shaped so as to be insertable into the space created by recessed edge 216a, 216b. In this way, lateral portion 534a, 534b can hold and/or lift a plate 322 from a bottom surface of plate 322 rather than a side surface of plate 322.

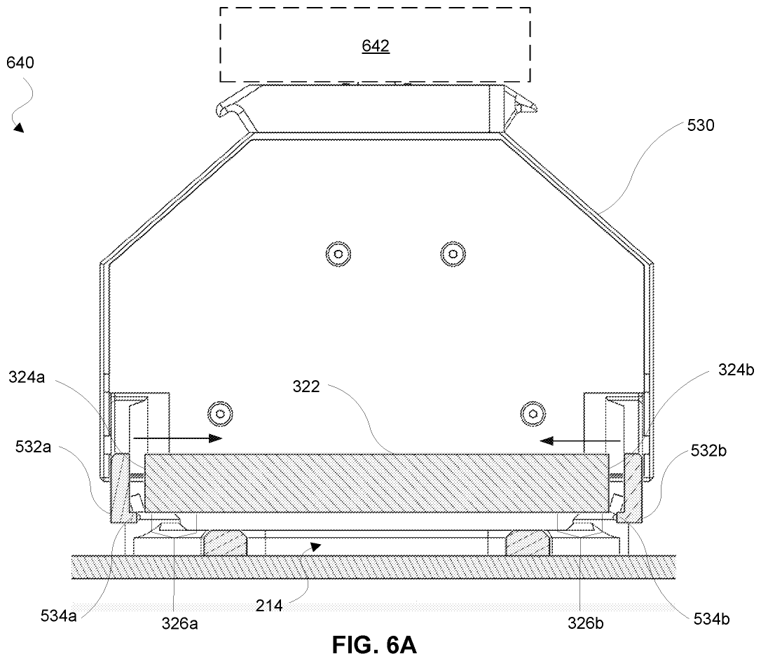

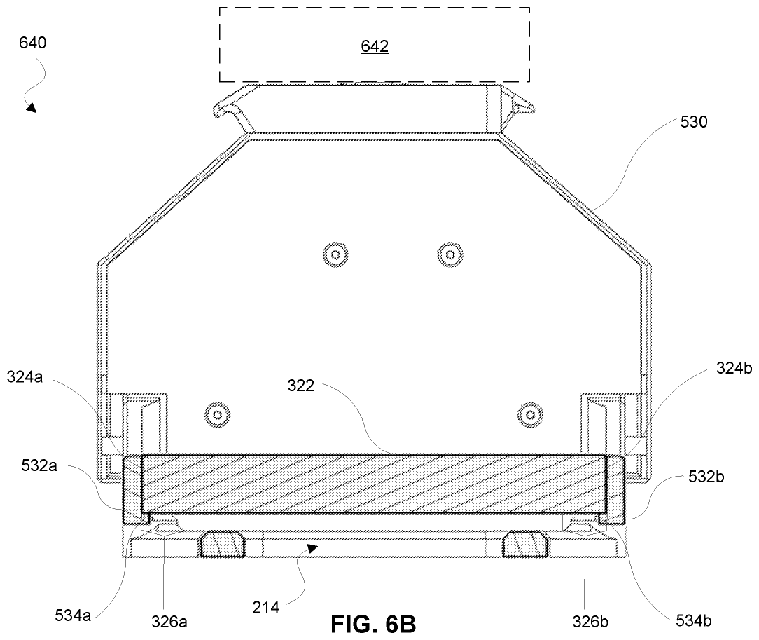

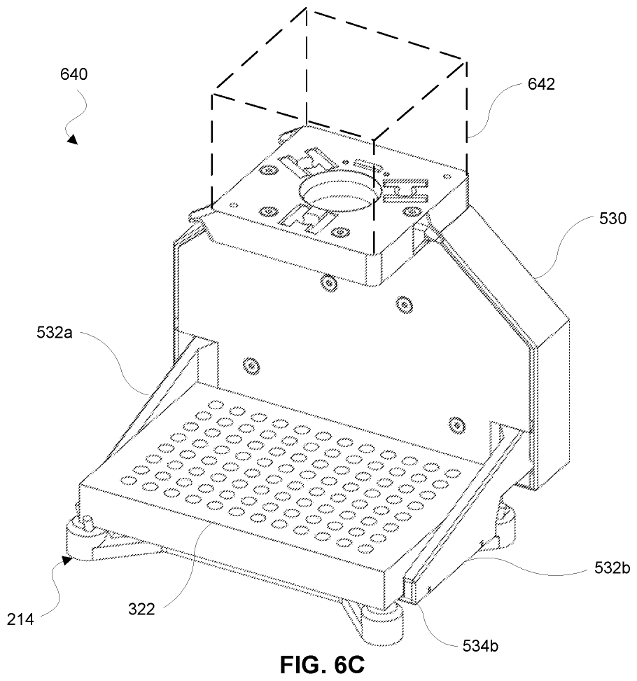

FIG. 6A represents a front cross-section view of a gripper system 640. As shown in FIG. 6A, gripper system 640 is not yet engaged with plate 322. FIGS. 6B-6C illustrate front cross-section and perspective views, respectively, of a gripper system 640 engaged with and supporting plate 322, according to some aspects. In some aspects, gripper system 640 can include a robotic arm 642, gripper 530, and gripper arms 532a, 532b having lateral portions 534a, 534b protruding inwards from sides of gripper arms 532a, 532b. Gripper 530 may interact with plate 322 in relation to plate holder 214.

In some aspects, robotic arm 642 can be coupled to a chassis, such as an overhead support structure. Robotic arm 642 can be an articulable manipulator capable of movement in some or all directions. This configuration can allow robotic arm 642 to move parallel to a deck containing a set of plate holders 214. Robotic arm 642 can then be able to move in a vertical direction (i.e., towards and away from the chassis) via an extension and retraction system internal to robotic arm 642. In this way, robotic arm 642 can reach any location on or within the volume of the chassis. In some aspects, the chassis may have a cuboid shape (e.g., cube, rectangular prism, trapezoidal prism, and the like) having a volume, such as a deck with an overhead and/or side support structure.

In some aspects, robotic arm 642 can be equipped with a set of modular tools that allows robotic arm 642 to interact with objects within the volume of or near the chassis supporting robotic arm 642. In some aspects, the set of modular tools can include a gripper, a magnetic mechanism, a suction mechanism, a lifter, or the like, for interaction with objects such as plates, tubes, bowls, arrays, and the like. In some aspects, robotic arm 642 can be configured to remove and replace one of the modular tools from the chassis. In one exemplary aspect, robotic arm 642 can be configured to remove and replace gripper 530 from the chassis.

In some aspects, robotic arm 642 can operate to move an object, such as plate 322, to a location on or within a biological processing environment. In some aspects, robotic arm 642 can place, insert, or otherwise deliver plate 322 to plate holder 214 mounted on a deck. Robotic arm 642 can then access plate 322 to move it to another plate holder 214 for processing.

In some aspects, robotic arm 642 can include gripper 530 to interact with plate 322. In some aspects, gripper 530 can include gripper arms 532a, 532b configured to support plate 322 from underneath. Gripper 530 can be configured to insert gripper arms 532a, 532b underneath plate 322 from opposing lateral directions, as illustrated by the arrows in FIG. 6A. In FIG. 6A, gripper arms 532a, 532b are spaced apart from opposing sides of plate 322, but moving inwards so as to engage with plate 322. FIGS. 6B and 6C illustrate gripper arms 532a, 532b after they have moved inwards to engage plate 322 from underneath. In some aspects, gripper arms 532a, 532b have lateral portions 534a, 534b that protrude inwardly from sides of gripper arms 532a, 532b, such that lateral portions 534a, 534b are located underneath plate 322 in the space created by recessed edges 216a, 216b of plate holder 214.

In some aspects, gripper 530 can be specifically designed to grip plate 322 from the sides in addition to underneath with a limited force. In one exemplary aspect, gripper 530 can be configured to support plate 322 with a low gripping force so that gripper 530's primary means of support is from underneath plate 322 rather than the sides of plate 322. A low gripping force also prevents gripper 530 from squeezing plate 322 so tightly that plate 322 moves, becomes dislodged, or is otherwise prevented from resting on lateral portions 534a, 534b when plate 322 is being held by gripper 530. In some aspects, the gripping force applied by gripper 530 is equal to or less than approximately 4.1667 kg. Gripper 530 can supply the proper amount of force with, for example and without limitation, an inexpensive hobbyist servo motor without the need for force-feedback sensors, which provides for a vastly improved cost outlay compared to prior art systems.

In some aspects, gripper arms 532a, 532b can be configured to engage only with opposing portions of the bottom surface of plate 322. In some aspects, gripper arms 532a, 532b can be configured to simultaneously engage both with opposing sides of plate 322 and portions of the bottom surface of plate 322 adjacent to the opposing sides of plate 322 for stable support. In some aspects, gripper arms 532a, 532b can be configured to simultaneously engage with plate sides 324a, 324b and plate bottom surface portion 326a, 326b adjacent to plate sides 324a, 324b. In some aspects, gripper arms 532a, 532b can be any shape and size to enable simultaneous engagement with opposing sides of plate 322 and portions of the bottom surface of plate 322 adjacent to the opposing sides of plate 322. In one exemplary aspect, gripper arms 532a, 532b can be shaped in an “L” shape, with lateral portions 534a, 534b forming the lower part of the “L”. With these exemplary configurations, gripper arms 532a, 532b can support plate 322 more reliably than the prior art systems which depend upon precariously applying force only to opposing sides of a plate.

In some aspects, gripper arms 532a, 532b can provide a side gripping option as an additional or alternative support for plate 322. In some aspects, gripper arms 532a, 532b can be equipped with prongs 112 disposed on lateral portions 534a, 534b. For example, in some aspects where gripper arms 532a, 532b have an “L” shape, prongs 112 may be displosed on the lateral portions of the “L” shape. Gripper arms 532a, 532b can thus support and lift plate 322 when used with plate holder 214, but use prongs 112 to lift plate 322 when used with a traditional plate holder 102. In some aspects, gripper arms 532a, 532b can remove a lid from an object on plate 322 using prongs 112.

It is to be appreciated that the Detailed Description section, and not the Summary and Abstract sections, is intended to be used to interpret the claims. The Summary and Abstract sections may set forth one or more but not all exemplary aspects of the present invention as contemplated by the inventor(s), and thus, are not intended to limit the present invention and the appended claims in any way.

The aspects have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific aspects will so fully reveal the general nature of the invention that others can, by applying knowledge within the skill of the art, readily modify and/or adapt for various applications such specific aspects, without undue experimentation, without departing from the general concept of the present invention. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary aspects, but should be defined only in accordance with the following claims and their equivalents.

1. A system comprising:
a plate comprising a plurality of sides, a bottom surface, and a top surface;
a robotic arm;
a gripper coupled to the robotic arm, wherein the gripper comprises gripper arms that are sized and shaped to extend underneath the plate from opposing lateral directions and support the plate from underneath;
a plate holder sized and shaped to support the plate, wherein:
the plate holder includes recessed edges configured to allow the gripper arms sufficient access to opposing sides of the plurality of sides of the plate and portions of the bottom surface of the plate adjacent to the opposing sides of the plate, and
the plate holder includes alignment guides configured to align the plate with a predetermined position on the plate holder.

2. The system of claim 1, wherein the plate is a 96-well biological processing plate.

3. The system of claim 1, wherein the plate comprises at least one of biological sample wells, tip racks, or test tube holders.

4. The system of claim 1, wherein the plate comprises a length of approximately 127.76 mm and a width of approximately 85.48 mm.

5. The system of claim 1, further comprising a chassis that supports the robotic arm and a set of modular tools containing the gripper, wherein the robotic arm is configured to remove and replace the gripper from the chassis.

6. The system of claim 1, wherein the gripper arms are sized and shaped in an “L” shape configured to simultaneously engage with opposing sides of the plate and portions of the bottom surface of the plate adjacent to the opposing sides of the plate and support the plate from underneath.

7. The system of claim 1, wherein the gripper is configured to support the plate with a gripping force equal to or less than approximately 4.1667 kg.

8. The system of claim 1, wherein the plate holder comprises mounting sites compatible with attachment areas on a mounting deck.

9. The system of claim 1, wherein the alignment guides are angled guide pins disposed on opposite corners of the plate holder.

10. An apparatus comprising:
a plate comprising a plurality of sides, a bottom surface, and a top surface; and
a plate holder sized and shaped to support the plate, wherein:
the plate holder includes recessed edges configured to allow gripper arms on a gripper sufficient access to opposing sides of the plurality of sides of the plate and portions of the bottom surface of the plate adjacent to the opposing sides of the plate, and
the plate holder includes alignment guides configured to align the plate with a predetermined position on the plate holder.

11. The apparatus of claim 10, wherein the plate is a 96-well biological processing plate.

12. The apparatus of claim 10, wherein the plate comprises at least one of biological sample wells, tip racks, or test tube holders.

13. The apparatus of claim 10, wherein the plate holder comprises mounting sites compatible with attachment areas on a mounting deck.

14. The apparatus of claim 10, wherein the alignment guides are angled guide pins disposed on opposite corners of the plate holder.

15. An apparatus comprising:
a plate comprising a plurality of sides, a bottom surface, and a top surface; and
a gripper coupled to a robotic arm, wherein the gripper comprises gripper arms that are sized and shaped to extend underneath the plate from opposing lateral directions and support the plate from underneath.

16. The apparatus of claim 15, wherein the plate is a 96-well biological processing plate.

17. The apparatus of claim 15, wherein the plate comprises at least one of biological sample wells, tip racks, or test tube holders.

18. The apparatus of claim 15, further comprising a chassis that supports the robotic arm and a set of modular tools containing the gripper, wherein the robotic arm is configured to remove and replace the gripper from the chassis.

19. The apparatus of claim 15, wherein the gripper arms are sized and shaped in an “L” shape to simultaneously engage with opposing sides of the plate and portions of the bottom surface of the plate adjacent to the opposing sides of the plate and support the plate from underneath.

20. The apparatus of claim 15, wherein the gripper is configured to support the plate with a gripping force equal to or less than approximately 4.1667 kg.
